(19) United States
(12) Patent Application Publication
(10) Pub. No.: US 2017/0372224 A1
(43) Pub. Date: Dec. 28, 2017

(54) DEEP LEARNING FOR IMPUTATION OF INDUSTRIAL MULTIVARIATE TIME-SERIES

(71) Applicant: General Electric Company, Schenectady, NY (US)

(72) Inventor: Johan Michael REIMANN, Clifton Park, NY (US)

(21) Appl. No.: 15/195,347

(22) Filed: Jun. 28, 2016

(51) Int. Cl. G06N 99/00; G06N 5/02

(52) U.S. Cl. CPC G06N 99/005; G06N 5/022

(57) ABSTRACT

A method for imputing multivariate-time series data in a predictive model includes performing historical training of the predictive model by accessing data element information obtained from a real world physical asset, the data element information representing operational characteristics or measurements of the real world physical asset, examining configuration details of the real world physical asset, evaluating an expressiveness of the predictive model by comparing the predicative model to the configuration details, developing the model to express the configuration details, training the developed model by running scenarios based on the data element information, comparing error metrics between a model prediction and a corresponding one of the data element information, deploying the model if the error metrics are within predetermined parameters, and retraining the model if the error metrics are outside the predetermined parameters. A non-transitory computer readable medium and a system for implementing the method are also disclosed.

### BACKGROUND

Time series data can be found in nearly every domain where data is measured and recorded. For each of these data measurements, missing values can occur (e.g., not measured, lost measurements, outlier measurement, results eliminated, etc.). Data processing and analysis that rely on complete data sets can have problems when there are missing values. Missing values can be replaced through imputation (i.e., replacement with substitute values). Conventional imputation techniques can include multiple imputation, expectation-maximization, and nearest neighbor methods.

A common approach for analyzing stationary multivariate time series (when no latent variables are involved) is the vector autoregressive (VAR) model approach, which itself is an extension of the univariate autoregressive (AR) model. Other approaches for imputing multivariate data include joint modeling (JM) and fully conditional specification (FCS), also known as multivariate imputation by chained equations (MICE).

### BRIEF DESCRIPTION OF THE DRAWINGS

FIG. 1 depicts a system for implementing deep learning techniques to impute missing multivariate time series data in accordance with embodiments; and

FIG. 2 depicts a process for implementing deep learning techniques in accordance with embodiments.

### DETAILED DESCRIPTION

Embodying systems and methods provide a computer system with discrete units configured to implement deep learning techniques that extract and describe multivariate relationships in massive scale time-series data. These relationships are captured in a stochastic generative model, which in turn is used to impute missing information from the time-series sequences. Embodying systems include new algorithms and enabling software that improve data quality, which results in direct enhancement of industrial operations and/or equipment asset performance predictability.

Embodying systems and methods can be implemented on software platforms designed for the industrial Internet. Industrial Internet platforms enable asset and operations optimization by providing a standard way to run industrial-scale analytics and connect machines, data, and people. Deployed on machines, on premise, or in the cloud, an industrial Internet platform can combine a stack of technologies for distributed computing and big data analytics, asset management, machine-to-machine communication, and mobility. For example, factories can run more efficiently by collecting, analyzing, and applying production data; cars can be more reliable through continuous self-analysis of their various mechanical/electrical systems; etc.

In accordance with embodiments, systems and methods can extract and describe multivariate relationships in massive scale time-series data obtained by monitoring factories, cars, homes, hospitals, etc., and impute missing information for the acquired time-series data using a stochastic generative model.

In an embodying implementation, time-series data can be collected in real time from distributed, disparately structured sources. This collected data (stored in a central enterprise data store) can be used in support of a range of systems and procedures. Embodying systems can be flexible enough to provide a set of data models adaptable to reflect various types of assets (and related events, personnel and materials) deployed across various operations. Source data elements from existing automation and systems can then be mapped to the items defined in the model. Data analysis can yield information that provides maintenance systems with asset usage data to predict servicing intervals; compute comparative views of asset and process health across like assets or installations, regardless of differences in underlying automation and systems; use data and calculations as the basis for triggering a range of corrective or keep-running actions, delivered through electronic work instruction systems like Workflow, or even as an output to existing remote monitoring and control systems—for example, Supervisory Control And Data Acquisition (SCADA). It is this collected, multivariate time-series data that could require imputation to achieve more accurate, stable results.

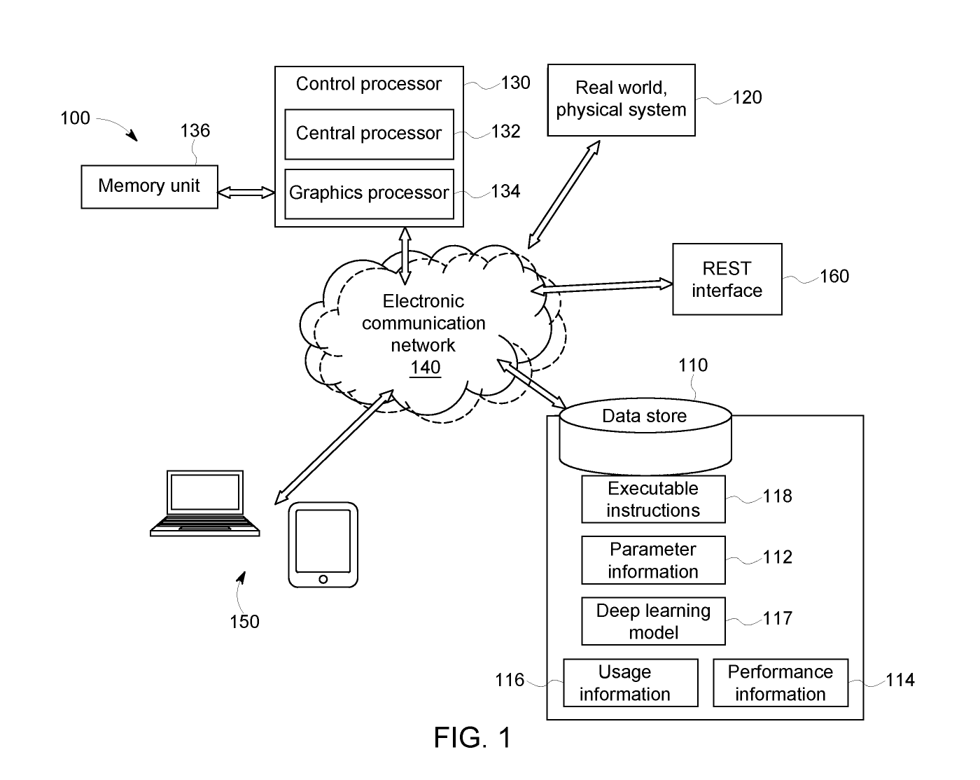

FIG. 1 depicts system 100 for deep learning imputation of multivariate time-series in accordance with embodiments. The components of system 100 can be located locally to each other, or remotely, or a combination thereof. Communication between the system components can be over an electronic communication network 140.

The electronic communication network can be an internal bus, or one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

A user may access system 100 via one of the user platforms 150 (e.g., a personal computer, tablet, smartphone, etc.). System 100 can store information into and/or retrieve information from various data sources, such as data store 110 and/or user platforms 150. The various data sources may be locally stored or reside remote from system 100.

The information stored and accessed can be related to the operation and/or status of real world physical system 120. For purposes of discussion, only one real world physical system is illustrated in FIG. 1. However, the invention is not so limited and multiple real world physical systems can be connected to system 100. The real world physical system can be an electro-mechanical system (e.g., a turbine engine for aircraft, locomotive, power generator, etc.), a consumer appliance (refrigerator, dishwasher, clothes washer, etc.), an industrial plant (e.g., chemical production, oil refinery, automated assembly, etc.). Each of these real world physical systems can include process control devices, monitors, sensors, automated valves, etc., each of which can provide data elements for storage in data store 110 as parameter information 112, performance information 114, and usage information 116.

System 100 can also include control processor 130, which operates executable instructions 118 stored in data store 110. These executable instructions can cause control processor 110 to perform embodying methods to enhance the ability of deep learning model 117 to predict performance of the real world physical asset(s).

Representational State Transfer (REST) interface 160 can access the contents of data store 110 to complete missing data by imputation in accordance with embodiments. Implementing a REST interface permits standardized interfaces and protocols to be used by clients and servers to exchange representations of resources. REST is not dependent on any protocol, but many RESTful services use hypertext transfer protocol (“HTTP”) as an underlying protocol.

The control processor can include a central processor unit 132, and a graphics processor unit 134. In communication with control processor 130 is memory unit 136, which can be random access memory (RAM) and/or read only memory (ROM). During operation, executable instruction 118 can be loaded into memory unit 136.

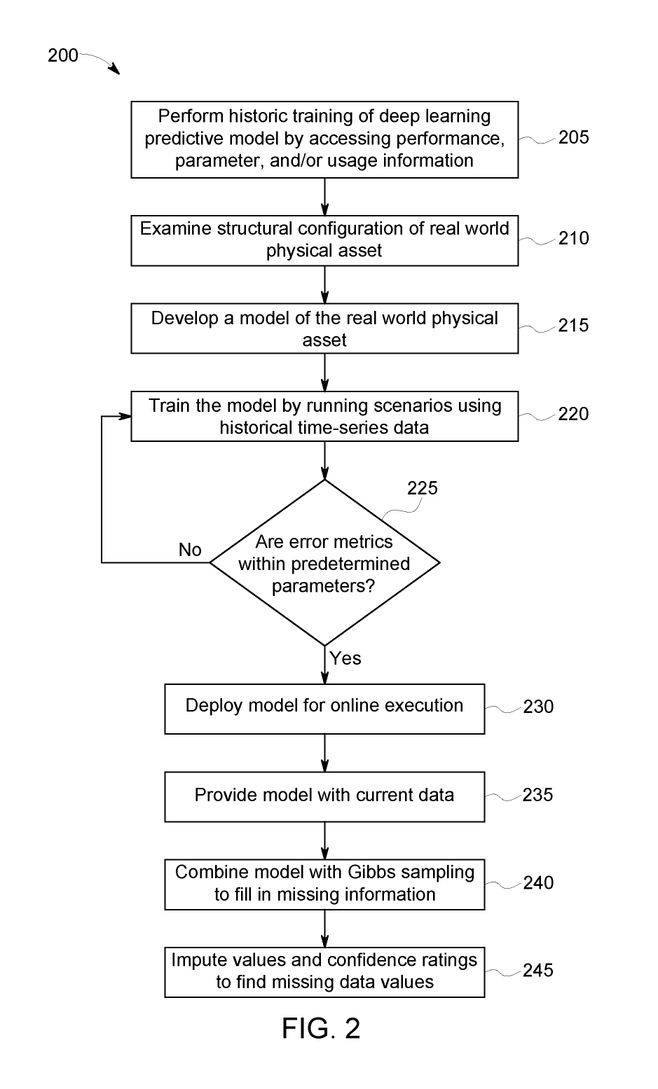

FIG. 2 depicts process 200 for implementing deep learning techniques to extract, describe, and/or impute multivariate time-series data for industrial operations and/or equipment asset performance predictability model(s) in accordance with embodiments. Process 200 can rely on two partitions. An offline portion of the process performs historical training, step 205, by accessing parameter information 112, performance information 114, and/or usage information 116. Part of the historical training examines the extent of available data and analyzes the data for patterns. The structure of the physical asset configuration is examined, step 210, to evaluate the expressiveness (i.e., detail) of the model. From this analysis a model is developed, step 215.

As opposed to conventional voice recognition or conventional image processing applications, which both often use deep learning techniques, there can be specific problems and/or challenges in obtaining historical information for an industrial asset. For example, some industrial assets can be years, or even decades old. Often industrial assets evolve over time (upgrades, redesigns, superseding models, etc.). These older industrial assets might not even have sensors; or perhaps their sensors are insufficient to be able to reconstruct a complete picture of the asset's performance throughout its operating life.

Embodying systems and methods for deep learning imputation of multivariate time-series can include the ability to reconcile the older, low-quality data (due to older sensor packages and/or communication hardware and protocols of the older model industrial asset(s)) with the new enhanced insights of a more updated industrial asset's wear and/or usage information obtained from a more updated industrial asset. Leveraging the reconciled older data with the new asset's information increases the accuracy of the imputed time-series. For example, if a gas turbine gets a burner upgrade, that information can be accounted for when imputing temperature values in the multivariate time-series data.

After the model is developed, scenarios are run using the historical time-series data to train the model, step 220. The model is deemed sufficiently trained when evaluations, step 225, of error metrics on the predictability of the model are within predetermined parameters.

After the deep learning model is deemed sufficiently trained, it is deployed, step 230, for online execution. When online, the model is provided with current data, step 235, representing updated sequences of observations. The model can be combined with Gibbs sampling, step 240, to fill in missing information in the multi-variate times series data. In some implementations, Maximum likelihood samples can also be generated. The deep learning model imputes values and confidence ratings, step 245, to find the most likely value of the missing information. In accordance with embodiments, imputed values are generated without impacting the underlying distribution of the known data.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform methods discussed herein such as imputing multivariate time-series data for industrial operations and/or equipment asset performance predictability model(s), as described above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

I claim:

1. A computer-implemented method for imputing multivariate-time series data in a predictive model, the method comprising:
performing historical training of the predictive model by accessing data element information obtained from a real world physical asset, the data element information representing operational characteristics or measurements of the real world physical asset;
examining configuration details of the real world physical asset;
evaluating an expressiveness of the predictive model by comparing the predicative model to the configuration details;
developing the model to express the configuration details;
training the developed model by running scenarios based on the data element information;
comparing error metrics between a model prediction and a corresponding one of the data element information;
deploying the model if the error metrics are within predetermined parameters; and
retraining the model if the error metrics are outside the predetermined parameters.

2. The method of claim 1, the data element information including at least one of parameter information, performance information, and usage information.

3. The method of claim 1, including providing the model with current data representing updated sequences of data element observations.

4. The method of claim 1, including combining the model with Gibbs sampling to fill in missing information.

5. The method of claim 1, including generating maximum likelihood samples.

6. The method of claim 1, including imputing at least one of values and confidence ratings to determine a most likely value for missing information.

7. The method of claim 1, including generating imputed values that conform to an existing data distribution of the data element information.

8. A non-transitory computer readable medium containing computer-readable instructions stored therein for causing a computer processor to perform operations for imputing multivariate-time series data in a predictive model, the operations comprising:
performing historical training of the predictive model by accessing data element information obtained from a real world physical asset, the data element information representing operational characteristics or measurements of the real world physical asset;
examining configuration details of the real world physical asset;
evaluating an expressiveness of the predictive model by comparing the predicative model to the configuration details;
developing the model to express the configuration details;
training the developed model by running scenarios based on the data element information;
comparing error metrics between a model prediction and a corresponding one of the data element information;
deploying the model if the error metrics are within predetermined parameters; and
retraining the model if the error metrics are outside the predetermined parameters.

9. The non-transitory computer-readable medium of claim 8, including instructions to cause the processor to perform the step of including in the data element information at least one of parameter information, performance information, and usage information.

10. The non-transitory computer-readable medium of claim 8, including instructions to cause the processor to perform the step of providing the model with current data representing updated sequences of data element observations.

11. The non-transitory computer-readable medium of claim 8, including instructions to cause the processor to perform the step of combining the model with Gibbs sampling to fill in missing information.

12. The non-transitory computer-readable medium of claim 8, including instructions to cause the processor to perform the step of generating maximum likelihood samples.

13. The non-transitory computer-readable medium of claim 8, including instructions to cause the processor to perform the step of imputing at least one of values and confidence ratings to determine a most likely value for missing information.

14. The non-transitory computer-readable medium of claim 8, including instructions to cause the processor to perform the step of generating imputed values that conform to an existing data distribution of the data element information.
